(19) United States
(12) Patent Application Publication
(10) Pub. No.: US 2001/0020531 A1
(43) Pub. Date: Sep. 13, 2001

(54) Brine viscosification for enhanced oil recovery

(76) Inventors: Ramesh Varadaraj, Flemington, NJ (US); Donald Bruce Siano, Westfield, NJ (US); Jan Bock, Oxford (GB)

Correspondence Address: EXXONMOBIL RESEARCH AND ENGINEERING COMPANY, P.O. BOX 900, 1545 ROUTE 22 EAST, ANNANDALE, NJ, 08801-0900, US

(21) Appl. No.: 09/739,307

(22) Filed: Dec. 18, 2000

Related U.S. Application Data
(63) Continuation-in-part of application No. 09/320,968, filed on May 27, 1999, now abandoned.

(51) Int. Cl. E21B 43/22; C09K 7/02

(52) U.S. Cl. 166/270.1; 166/270; 507/225; 507/261

(57) ABSTRACT

The present invention is related to an aqueous composition of at least one hydrophobically associating polymer and at least one surfactant, the mixture's viscosity being substantially constant or increased over temperatures ranging from about 20° C. to about 100° C. In another embodiment, the invention is related to a method for recovering oil from a subterranean reservoir by injecting into the reservoir a mixture of at least 100 to 25,000 ppm of a hydrophobically associating polymer per million parts by weight of water, about 25 to about 7,500 parts by weight per million parts by weight of water of one or more surfactants; and from about 0.5 wt. % to about 10 wt. %, based on the weight of water, of salts selected from the group consisting of alkali and alkaline earth metal halides and mixtures thereof.

This application is a continuation-in-part of a non-provisional application having U.S. Ser. No. 09/320,968.

### FIELD OF THE INVENTION

The present invention relates to improvements in brine viscosification, especially for use in enhanced crude oil recovery.

### BACKGROUND AT THE INVENTION

It has been apparent for many years that only a portion of the original oil in a reservoir can be produced by primary recovery methods, i.e., methods that rely on the energy in the formation. Secondary recovery methods such as waterflooding result in further crude oil production, but as much as half of the original oil may remain in the reservoir after application of primary and secondary methods. Enhanced oil recovery methods (“EOR”) have been proposed to substantially increase production beyond the yields obtained using primary and secondary recovery. According to some EOR methods, the depleted petroleum reservoir is flooded with brine through an injection well, the oil being recovered from a producing well in the same reservoir. Such methods sometimes use a surfactant, a polymer, or both in combination with the brine in order to improve oil recovery.

The production, handling, and flow of multi-component aqueous hydrocarbon mixtures, such as those encountered in EOR, present a number of technical difficulties resulting from component immiscibility and viscosity differences. One such difficulty is viscous fingering, which occurs when one component of a two component liquid is more easily transported through a porous medium as a result of that component's lower viscosity. Viscous fingering detrimentally affects EOR production from a partially depleted petroleum reservoir because, it is believed, the lower viscosity brine component bypasses the remaining oil and preferentially passes through regions of high permeability in the reservoir.

Viscous fingering may become more pronounced in high temperature regions of the reservoir because, as is well known, brine solutions have decreasing viscosity with increasing temperature.

There is therefore a need for improved EOR compositions and methods that make use of one or more surfactants in brine that provide a wide range of viscosities thereby permitting closer matching of the viscosity of the surfactant-brine solution to the crude oil and better mobility control. There is also a need for improved EOR compositions having a viscosity that is constant or increases with increasing temperature.

### SUMMARY OF THE INVENTION

In one embodiment, the invention is a composition for use in enhanced oil recovery, wherein the composition has a viscosity that either increases with increasing temperature or is substantially constant with increasing temperature. The composition comprises brine, from about 100 to 25,000 parts by weight of at least one hydrophobically associating polymer per million parts by weight of the brine, and from about 25 to about 7,500 parts by weight of at least one surfactant or mixtures thereof per million parts by weight of the brine. It is preferable that the hydrophobically associating polymer be selected from the group of partially hydrolyzed derivatives of copolymers of monoalkyl- and dialkyl-acrylamides of 4 to about 18 carbon atoms.

If a composition having increasing viscosity with increasing temperature is desired, it is preferred that the surfactant be a first nonionic surfactant having the formula:

R—O—(CH₂—CH₂—O)ₙ—H

wherein n is greater than 0 and less than 20, and R is from about 8 to about 22. Alternatively, when a composition having substantially constant viscosity with increasing temperature is desired, it is preferred that the surfactant be a mixture of the first nonionic surfactant combined with a second surfactant in a ratio sufficient to maintain the desired constant viscosity. The second surfactant may be either an anionic, cationic or nonionic surfactant, or mixtures thereof. The most preferred nonionic second surfactants have the formula:

R—O—(CH₂—CH₂—O)ₙ—H

wherein n is 20 and greater, and R is from about 8 to about 22.

A second embodiment of the invention is a method of preparing a composition for use in enhanced oil recovery, where the composition has either a viscosity that increased with increasing temperature or a viscosity that remains substantially constant with increasing temperature. The method has the steps of: (1) forming brine of water and salt; (2) adding to the brine from about 100 to about 25,000 parts by weight of at least one hydrophobically associating polymer per million parts by weight of the brine to form a brine and polymer mixture; and (3) adding to the brine and polymer mixture from about 25 to about 7,500 parts by weight of at least one surfactant or mixtures thereof per million parts by weight of the brine and polymer mixture. The polymer is selected from the same group as disclosed above. As also discussed previously, the surfactant may be selected from those disclosed above to form a composition having either increasing viscosity or substantially constant viscosity with increasing temperature, depending on the requirements of the user.

In another embodiment, the invention is a method for recovering oil from a subterranean formation with a composition having either a viscosity that increases with increasing temperature or a viscosity that is substantially constant with increasing temperature. The method has the steps of: (1) determining the viscosity of the oil to be recovered at reservoir temperature; (2) forming the composition in the manner described above; (3) injecting the composition into the subterranean formation; and (4) recovering the oil. It is preferred that the composition has a viscosity that is about 2-4 times that of the viscosity of the oil in the reservoir.

### BRIEF DESCRIPTION OF THE DRAWINGS

FIG. 1 shows the influence of the degree of ethoxylation on the viscosity of linear polydisperse ethoxylate surfactants as a function of surfactant concentration.

FIG. 2 shows the influence of the degree of ethoxylation on the viscosity of branched polydisperse ethoxylate surfactants as a function of surfactant concentration.

FIG. 3 shows the effect of surfactant concentration on hydrophobically associating polymer solution.

FIG. 4 shows the effect of surfactant concentration on polymer solutions wherein the polymer does not contain a hydrophobic group.

FIG. 5 shows the influence of surfactant concentration in solutions that do not contain polymer.

FIG. 6 shows the dependence of viscosity as a function of temperature for aqueous mixtures of hydrophobically associating polymer containing 1,000 ppm of non-ionic surfactant.

### DESCRIPTION OF THE INVENTION

The invention is based on the discovery that a brine's viscosity can be continuously varied over the range of about 20 to about 2,500 centipoise by combining at least one hydrophobically associating polymer and at least one surfactant. More specifically, for brines containing from about 100 to about 25,000 parts by weight of a hydrophobically associating polymer per million parts by weight of the brine, it has been discovered that varying surfactant concentration in the brine over a range of about 25 to about 7,500 parts per million parts by weight of brine results in brine viscosities ranging from about 20 to about 2,500 centipoise.

The invention is also based on the discovery that the maximum viscosity for such a brine-surfactant-hydrophobically associating polymer mixture occurs at a surfactant concentration slightly below the surfactant's critical micelle concentration (“CMC”) for anionic, non-ionic, and cationic surfactants. Moreover, it has been discovered that aqueous mixtures of an appropriate amount of at least one hydrophobically associating polymer and an appropriate amount of at least one surfactant have a substantially constant or even increasing viscosity over typical reservoir temperature ranges.

The brines of the invention include a water and a salt selected from the group consisting of alkali and alkaline earth metal halides and mixtures thereof. The preferred salt is an alkali metal halide, especially chloride. Preferably, the salt is present in an amount ranging from about 0.5 to about 10 wt. % based on the weight of water. The preferred salinity will depend, among other criteria, on the salinity of the subterranean formation.

The hydrophobically associating polymers suitable in the practice of the present invention include copolymers of monoalkyl- or dialkyl- acrylamides with acrylamide and their partially hydrolyzed derivatives. The alkyl groups of the monoalkyl- and dialkyl-acrylamides will typically be in the range of about 4 to about 18 carbons atoms, and preferably will be in the range from about 6 to about 12 atoms. The mol % of the alkyl group in the polymer will typically be in the range of about 0.1 to 4.0, and preferably will be in the range from about 0.2 to 1.5.

A particularly preferred hydrophobically associating polymer used in the practice of the present invention is a copolymer of acrylamide and n-octylacrylamide which has been partially hydrolyzed to form a polymer containing from about 10 mol % to about 30 mol % carboxylic acid groups.

In the compositions of the present invention the hydrophobically associating polymer will be present in an amount ranging from about 100 to about 25,000 parts by weight per million parts of brine.

The surfactants are present in the composition of the present invention in an amount ranging from about 25 parts by weight to about 7,500 parts by weight per million parts by weight of brine and polymer mixture.

The surfactants suitable in the practice of the present invention are selected depending upon whether a composition having increasing viscosity with increasing temperature is desired or whether a composition having substantially constant viscosity with increasing temperature is desired. In the former case, first nonionic surfactants having the following chemical formula are used:

R—O—(CH₂—CH₂—O)ₙ—H

wherein

n is greater than 0 and less than 20; and

R is from about 8 to about 22.

It is most preferred that n be greater than 0 and less than 16. Specifically, preferred surfactants meeting these criteria are polyoxyethylene (10) oleyl ether, polyoxyethylene (10) octadecyl ether, polyoxyethylene (15) hexadecyl ether, and mixtures thereof.

In cases where a composition having a substantially constant viscosity with increasing temperature is desired, a surfactant mixture comprising at least one of the “increasing viscosity” first nonionic surfactants (as just described) and at least one “decreasing-viscosity” second surfactant may be combined in a ratio sufficient to provide the composition with substantially constant viscosity. The second surfactants may be selected from either a cationic, anionic or nonionic surfactant or mixtures thereof.

Typical anionic second surfactants are alkali metal salts of alkyl sulfates having from about 6 to 22 carbon atoms in the alkyl group, alkali metal salts of alkylethoxy sulfates having from about 6 to 22 carbon atoms in the alkyl group and having about 2 to 100 ethoxy groups, and branched alkyl sulfonate with the number of carbon atoms in the alkyl group ranging from about 6 to about 22. In the above surfactants, the preferred alkali metal is sodium. Typical cationic second surfactants are alkyltrimethylammonium bromide with about 6 to about 22 carbon atoms in the alkyl group.

The preferred anionic second surfactant is a sodium salt of branched alkyl sulfonate, and the preferred cationic second surfactant is cetyltrimethylammonium bromide.

The preferred type of nonionic second surfactants have the formula:

R—O—(CH₂—CH₂—O)ₙ—H

wherein

n is preferably from 20 to about 150; and

R is from about 8 to about 22.

The most preferred nonionic second surfactants are polyoxyethylene (20) oleyl ether, polyoxyethylene (23) dodecyl ether, polyoxyethylene (100) stearyl ether, and mixtures thereof. The properties of surfactant mixtures, such as viscosity, may be calculated from linear combinations of component surfactant properties according to methods known in the art.

In the practice of the invention, preferably the crude oil's viscosity is estimated or determined and the above-disclosed composition is formed, the composition having a substantially equal or greater viscosity than the crude oil's viscosity. The viscosity determination may be performed at ambient temperatures, or preferably at elevated temperatures more representative of reservoir temperatures. Such a composition is capable of efficiently displacing the crude oil during recovery as the composition is injected into the subterranean formation. More preferably, the composition will have a viscosity that is substantially constant or increases at increased reservoir temperatures. It is most preferred that the viscosity of the composition be two to four times the viscosity of the crude oil.

While not wishing to be bound by any theory, it is believed that hydrophobically associating polymers interact with aqueous surfactant solutions at or near the CMC in a way that causes the polymer associations to be considerably strengthened. This strengthening is believed to result from the presence of pre-micellar aggregates of surfactants in the solution. Accordingly, it is preferable to first determine the viscosity of the crude oil in the reservoir and to evaluate the reservoir permeability in order to select a polymer-surfactant brine composition having a viscosity substantially equal to or greater than the viscosity of the petroleum.

The compositions of the invention can be easily prepared, within the range of parameters outlined above, which will have the requisite viscosity. In general, the polymer is first dissolved in the brine, then the surfactant is added, and the components are mixed at room temperature.

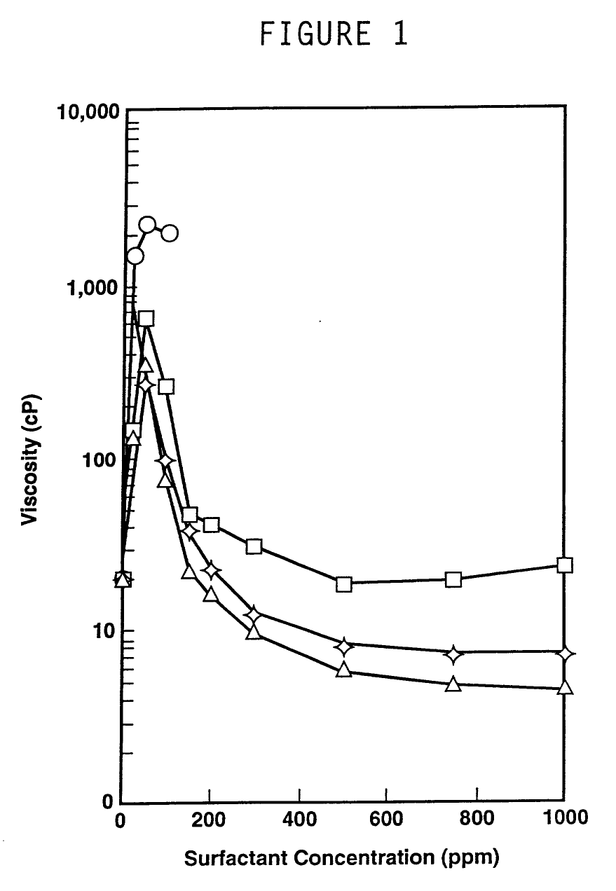

In many cases, it is desirable to use the minimum amount of surfactant necessary to provide the greatest increase in brine viscosity. As shown in FIGS. 1, 2, and 3 for a wide range of surfactants, the greatest brine viscosity is obtained at a molar surfactant concentration generally ranging from about 85% to about 100% of the CMC. Providing surfactant concentrations in this range is beneficial because, among other reasons, the brine's viscosity is a weak function of surfactant concentration near the maximum, and consequently the brine's viscosity will be relatively insensitive to small changes in surfactant concentration, as shown in FIGS. 1, 2, and 3. Where a mixture of surfactants is used, the desired surfactant concentration should preferably be in the range of about 85% to about 100% of a linear combination of the individual CMCs.

### EXAMPLE 1

FIG. 1 shows a system in which the concentration of polymer is 2,000 ppm in 2% NaCl. The polymer is a hydrolyzed acrylamide-octylacrylamide copolymer where the degree of hydrolysis is 18% and the mole fraction of octylacrylamide in the copolymer is 1.25%. The behavior of the viscosity at a shear rate of 1 s⁻¹ is shown as surfactant concentration is varied. The behavior for four different surfactants is shown. The surfactants all have a linear dodecyl moiety as the hydrophobe, and are polydisperse in the number of ethoxylate groups. In the figure, circular points represent a linear C₁₂ surfactant and an average of 3 ethoxylate groups. Square points represent a linear C₁₂ surfactant having an average of 5 ethoxylate groups. Diamond points represent a linear C₁₂ surfactant having an average of 6 ethoxylate groups, and triangular points represent a linear C₁₂ surfactant having an average of seven ethoxylate groups. The figure's ordinate shows the viscosity in centipoise and the abscissa shows surfactant concentration in ppm. As can be seen in the figure, the viscosity of each of the solutions is dramatically increased at a surfactant concentration of about 100 ppm. This is in the CMC range for each of the surfactants. The increase is more than a factor of 15 for all of them and is as much as a factor of 100 for one of them. The combination of surfactant and polymer is clearly much more effective than either polymer or surfactant alone.

### EXAMPLE 2

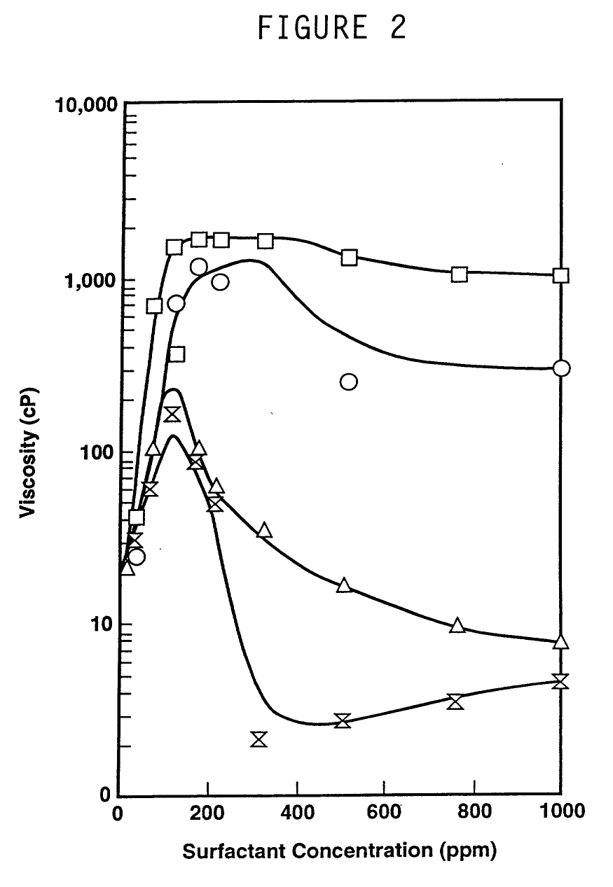

FIG. 2 shows the results of measurements using the same polymer and salt in the same concentration as used in Example 1. However, the results in FIG. 2 were obtained using a variety of other nonionic surfactants which are similar in structure to those of Example 1 except that the alkyl hydrophobe of the surfactant is branched. Again, even at very low surfactant concentrations, the viscosity is very substantially increased. The surfactant concentration range where viscositification is maximum is in the CMC range for each of the surfactants.

In FIG. 2, square points represent a branched C₁₂ surfactant having an average of 6 ethoxylate groups, hour-glass points represent a branched C₁₂ surfactant having an average of 7 ethoxylate groups, circular points represent a branched C₁₂ surfactant with an average of 5 ethoxylate groups, and triangular points represent a branched C₁₂ surfactant having an average of 4 ethoxylate groups. The ordinate shows the viscosity and the abscissa shows concentration as in FIG. 1.

Examples of some polymer-surfactant fluids compositions useful in the present invention are given in Table 1. As can be seen, fluid viscosities ranging from 17 to about 2,500 centepoise are achievable.

TABLE 1

| | SALT | | SURFACTANT | FLUID VISCOSITY @ |
|---|---|---|---|---|
| POLYMER | WT. % NaCl | SURFACTANT | CONC. (ppm) | 1.28s⁻¹ (cP) |
| P1 | 2.0 | $l - {C}_{8} {H}_{17} ( {OCH}_{2} {CH}_{2} ) \frac{m}{5} - OH$ | 400 | 17 |
| P2 | 3.3 | $l - {C}_{8} {H}_{35} ( {OCH}_{2} {CH}_{2} ) \frac{p}{5} - 10$ | 50 | 66 |
| P3 | 3.3 | l-Cₗ₂H₂₅(SO₄⁻Na⁺) | 2,500 | 154 |
| P1 | 2.0 | $Br - {C}_{12} {H}_{25} ( {OCH}_{2} {CH}_{2} ) \frac{p}{7} - OH$ | 100 | 224 |
| P3 | 3.3 | l-C₁₂H₂₅(SO₄⁻Na⁺) | 5,000 | 241 |
| P1 | 2.0 | $l - {C}_{12} {H}_{25} ( {OCH}_{2} {CH}_{2} ) \frac{p}{5} - OH$ | 100 | 348 |
| P1 | 2.0 | $Br - {C}_{12} {H}_{25} ( {OCH}_{2} {CH}_{2} ) \frac{p}{5} - OH$ | 50 | 485 |
| P1 | 2.0 | $l - {C}_{13} {H}_{27} ( {OCH}_{2} {CH}_{2} ) \frac{m}{5} - OH$ | 750 | 561 |
| P1 | 2.0 | $Br - {C}_{12} {H}_{25} ( {OCH}_{2} {CH}_{2} ) \frac{m}{5} - OH$ | 500 | 845 |
| P1 | 2.0 | $l - {C}_{12} {H}_{25} ( {OCH}_{2} {CH}_{2} ) \frac{p}{6} - OH$ | 25 | 927 |
| P1 | 2.0 | $l - {C}_{12} {H}_{25} ( {OCH}_{2} {CH}_{2} ) \frac{p}{5} - OH$ | 200 | 1028 |
| P1 | 2.0 | $Br - {C}_{12} {H}_{25} ( {OCH}_{2} {CH}_{2} ) \frac{p}{4} - OH$ | 200 | 1450 |
| P1 | 2.0 | l-C₁₂H₂₅(OCH₂CH₂)₃⁻SO₄-Na⁺ | 25 | 1534 |
| P1 | 2.0 | $l - {C}_{12} {H}_{25} ( {OCH}_{2} {CH}_{2} ) \frac{p}{5} - OH$ | 100 | 348 |
| P1 | 2.0 | $Br - {C}_{12} {H}_{25} ( {OCH}_{2} {CH}_{2} ) \frac{p}{5} - OH$ | 300 | 2128 |

POLYMERS
P1 = Copolymer of n-octylacrylamide and acrylamide; 1.25 mole % n-octyl content; 18% hydrolysis; 2000 ppm concentration
P2 = Copolymer of n-octylacrylamide and acrylamide; 0.75 mole % n-octyl content; 18% hydrolysis; 1500 ppm concentration
P3 = Terpolymer of n-octylacrylamide, acrylamide and 2-acrylamido-2-methylpropane sulfonate, 0.75 mole % n-octyl content; 2000 ppm concentration
SURFACTANTS
l = Linear hydrocarbon chain
Br = Branched hydrocarbon chain
m = Monodisperse ethoxy group
p = Polydisperse ethoxy group

### EXAMPLE 3

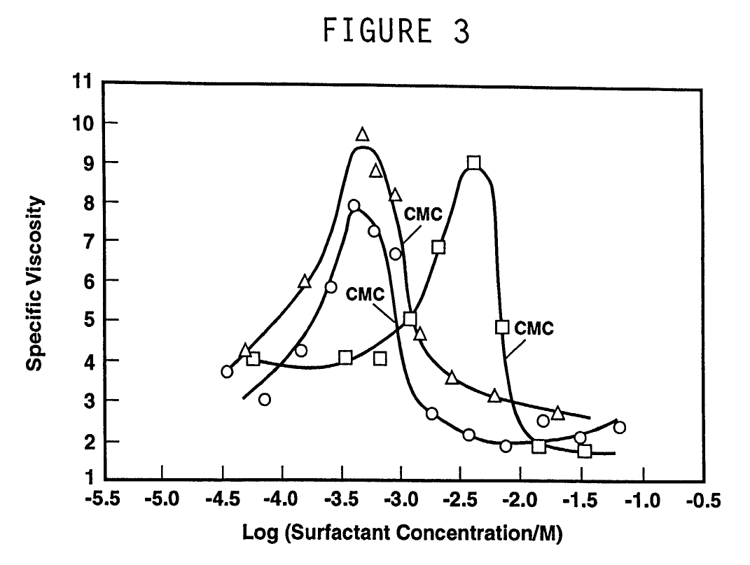

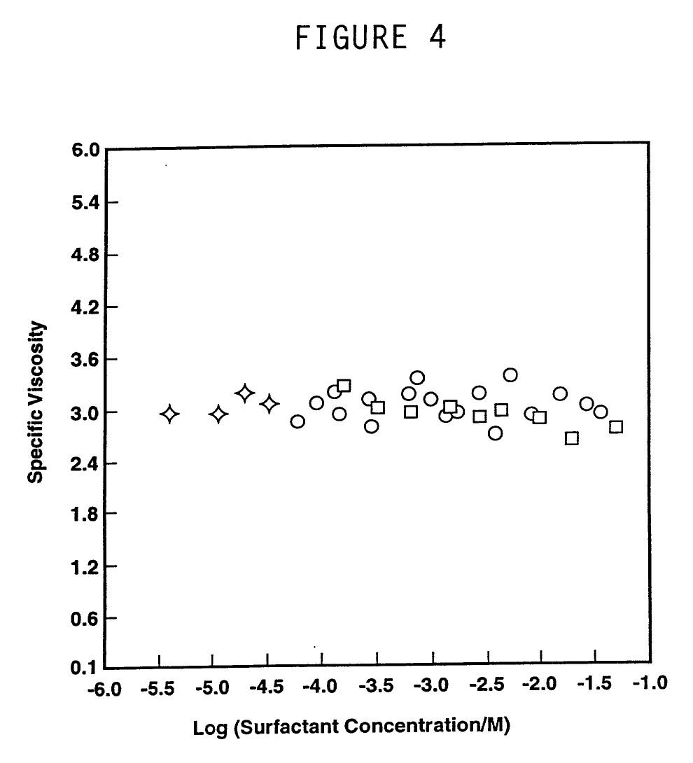

FIGS. 3 and 4 show a comparison of the behavior of two polymers, one of which does not contain a hydrophobic group (PAM 310X2), prepared by free radical polymerization under identical conditions. Neither of the polymers is hydrolyzed and both are dissolved in water at a concentration of 5000 ppm at 55° C. Again, very substantial increases in viscosity are seen for the hydrophobically associating polymer (FIG. 3), but not for the homopolyacrylamide (FIG. 4). As shown in FIG. 3, all three surfactants, cetyltrimethylammonium bromide (CTAB), sodium dodecylsufate (SDS) and a branched hexadecyl sulfonate, sodium salt (C₁₆SO₃), exhibit a viscosity maximum. The CMC of each of the surfactants are indicated on the curves, and it may be seen that the viscosity maximum occurs a little below the CMC of the surfactant.

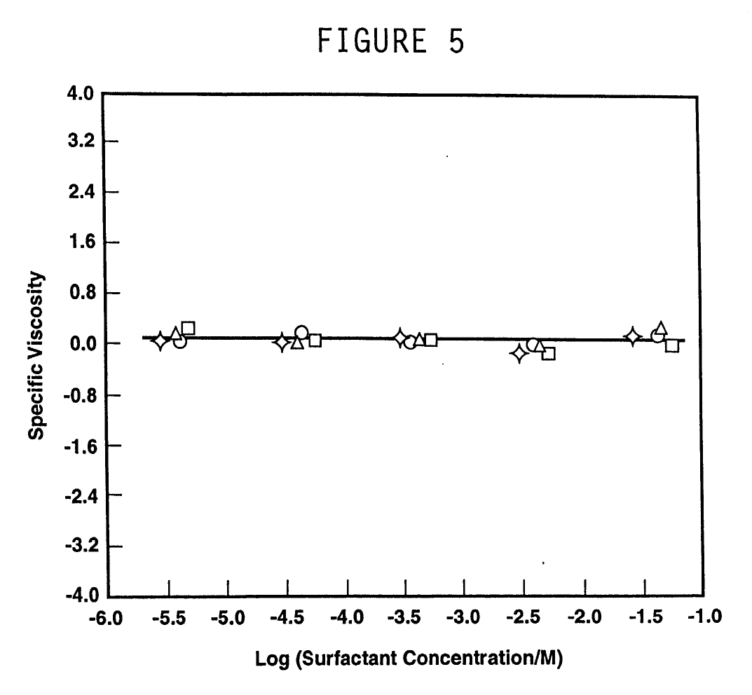

FIG. 5 shows the specific viscosity of these surfactants without polymer over the same concentration range. No viscosity maximum is present. In FIGS. 3, 4, and 5 diamonds represent the C₁₆SO₃ data, circles represent the CTAB data, rectangles represent the SDS data, and the diamonds represent the data from a linear C₁₂ surfactant having an average of 8 ethoxylate groups.

### EXAMPLE 4

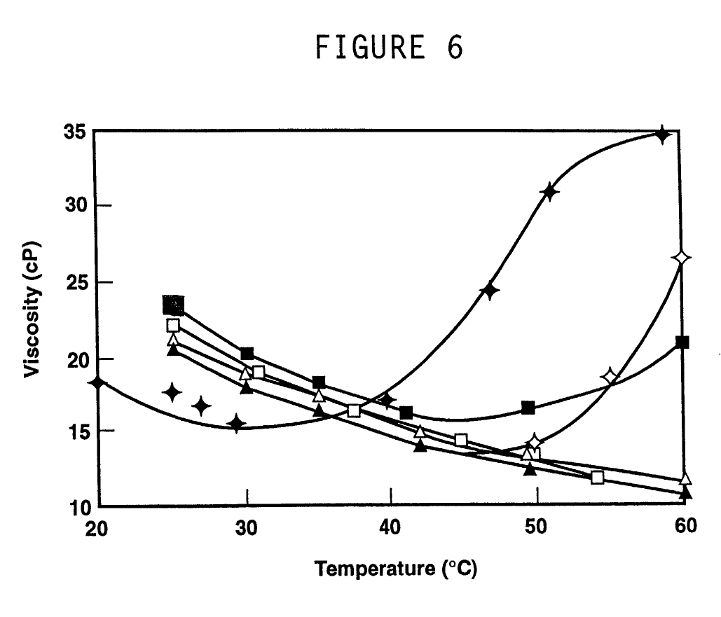

FIG. 6 shows the behavior of 1000 ppm aqueous solutions of 25% hydrolyzed alkyl polyacrylamide, when mixed with 1000 ppm of various nonionic surfactants. The copolymer had 0.75 mole % of octylacrylamide copolymerized with acrylamide, then hydrolyzed with base to a degree of hydrolysis of 25%. The surfactant solutions are represented as follows:

a) solid diamonds represent polyoxyethylene (10) oleyl ether surfactant;

b) open diamonds represent polyoxyethylene (10) octadecyl ether surfactant;

c) solid rectangles represent polyoxyethylene (15) hexadecyl ether surfactant;

d) open rectangles represent polyoxyethylene (100) stearyl ether surfactant;

e) solid triangles represent polyoxyethylene (20) oleyl ether surfactant; and

f) open triangles represent polyoxyethylene (23) dodecyl ether surfactant.

This figure shows that with three surfactants (a, b and c) the viscosity increases with rising temperature when the temperature was above about 40° C., while with three other surfactants (d, e and f) the viscosity decreases with an increase in temperature. Non-ionic surfactants with less than 20 oxyethylene groups exhibit the unexpected result of increasing viscosity with increasing temperature.

What is claimed is:

1. A composition for use in enhanced oil recovery and having one of a viscosity that increases with increasing temperature or a viscosity that is substantially constant with increasing temperature, the composition comprising:
(a) brine;
(b) from about 100 to about 25,000 parts by weight of at least one hydrophobically associating polymer per million parts by weight of the brine, the polymer being selected from the group of partially hydrolyzed derivatives of copolymers of monoalkyl- and dialkyl-acrylamides of 4 to about 18 carbon atoms with acrylamide; and
(c) from about 25 to about 7,500 parts by weight of at least one surfactant or mixtures thereof per million parts by weight of the brine, the surfactant selected from the group consisting of:
(i) first nonionic surfactants having the formula:
R—O—(CH₂—CH₂—O)ₙ—H
wherein
n is greater than 0 and less than 20; and
R is from about 8 to about 22,
whereby the composition has a viscosity that increases with increasing temperature; and
(ii) a surfactant mixture comprising:
(A) at least one of the first nonionic surfactants; and
(B) at least one second surfactant selected from the group consisting of anionic, cationic, and nonionic surfactants and mixtures thereof, the nonionic surfactants having the formula:
R—O—(CH₂—CH₂—O)ₙ—H
wherein
n is 20 and greater; and
R is from about 8 to about 22,
wherein the ratio of the first surfactant to the second surfactant is in an amount sufficient to provide a composition having a viscosity that is substantially constant with increasing temperature.

2. The composition of claim 1 wherein the first surfactant is selected from the group consisting of polyoxyethylene (10) oleyl ether, polyoxyethylene (10) octadecyl ether, polyoxyethylene (15) hexadecyl ether and mixtures thereof.

3. The composition of claim 1 wherein the second surfactant is selected from the group consisting of cetyltrimethylammonium bromide, a sodium salt of branched alkyl sulfonate, polyoxyethylene (100) stearyl ether, polyoxyethylene (20) oleyl ether, and polyoxyethylene (23) dodecyl ether and mixtures thereof.

4. A method of preparing a composition for use in enhanced oil recovery, the composition having one of a viscosity that increases with increasing temperature or a viscosity that is substantially constant with increasing temperature, the method comprising:
(a) forming a brine of water and salt, the salt being represented in an amount ranging from about 0.5 to about 10 wt. % based on the weight of water;
(b) adding to the brine from about 100 to about 25,000 parts by weight of at least one hydrophobically associating polymer per million parts by weight of the brine to form a brine and polymer mixture, the polymer being selected from the group of partially hydrolyzed derivatives of copolymers of monoalkyl- and dialkyl-acrylamides of 4 to about 18 carbon atoms with acrylamide; and
(c) adding to the brine and polymer mixture from about 25 to about 7,500 parts by weight of at least one surfactant or mixtures thereof per million parts by weight of the brine and polymer mixture, the surfactant selected from the group consisting of:
(i) first nonionic surfactants having the formula:
R—O—(CH₂—CH₂—O)ₙ—H
wherein
n is greater than 0 and less than 20; and
R is from about 8 to about 22.
whereby the composition has a viscosity that increase with increasing temperature; and
(ii) a surfactant mixture comprising:
(A) at least one of the first nonionic surfactants; and
(B) at least one second surfactant selected from the group consisting of anionic, cationic, and nonionic surfactants and mixtures thereof, the nonionic surfactants having the formula:
R—O—(CH₂—CH₂—O)ₙ—H
wherein
n is 20 and greater; and
R is from about 8 to about 22,
wherein the ratio of the first surfactant to the second surfactant is in an amount sufficient to provide a composition having a viscosity that is substantially constant with increasing temperature.

5. The method of claim 4 wherein the first surfactant is selected from the group consisting of polyoxyethylene (10) oleyl ether, polyoxyethylene (10) octadecyl ether, polyoxyethylene (15) hexadecyl ether and mixtures thereof.

6. The method of claim 4 wherein the second surfactant is selected from the group consisting of cetyltrimethylammonium bromide, a sodium salt of branched alkyl sulfonate, polyoxyethylene (100) stearyl ether, polyoxyethylene (20) oleyl ether, and polyoxyethylene (23) dodecyl ether and mixtures thereof.

7. A method for recovering oil from a subterranean formation with a composition having one of a viscosity that increases with increasing temperature or a viscosity that is substantially constant with increasing temperature, the method comprising:
(a) determining the viscosity of the oil to be recovered at reservoir temperature;
(b) forming the composition wherein the viscosity thereof is substantially equal to or greater than the oil viscosity, comprising the steps of:
(i) forming a brine of water and salt, the salt being present in an amount ranging from about 0.5 to about 10 wt. % based on the weight of water;
(ii) adding to the brine from about 100 to about 25,000 parts by weight of at least one hydrophobically associating polymer per million parts by weight of the brine to form a brine and polymer mixture, the polymer being selected from the group of partially hydrolyzed derivatives of copolymers of monoalkyl- and dialkyl-acrylamides of 4 to about 18 carbon atoms with acrylamide;
(iii) adding to the brine and polymer mixture from about 25 to about 7,500 parts by weight of at least one surfactant or mixtures thereof per million parts by weight of the brine and polymer mixture, the surfactant selected from the group consisting of:
(A) first nonionic surfactants having the formula:
R—O—(CH₂—CH₂—O)ₙ—H
wherein
n is greater than 0 and less than 20; and
R is from about 8 to about 22.
whereby the composition has a viscosity that increase with increasing temperature; and
(B) a surfactant mixture comprising:
(I) at least one of the first nonionic surfactants; and
(II) at least one second surfactant selected from the group consisting of anionic, cationic, and nonionic surfactants and mixtures thereof, the nonionic surfactants having the formula:
R—O—(CH₂—CH₂—O)ₙ—H
wherein
n is 20 and greater; and
R is from about 8 to about 22,
wherein the ratio of the first surfactant to the second surfactant is in an amount sufficient to provide a composition having a viscosity that is substantially constant with increasing temperature;
(c) injecting the composition into the subterranean formation; and
(d) recovering the oil.

8. The method of claim 7 wherein the first surfactant is selected from the group consisting of polyoxyethylene (10) oleyl ether, polyoxyethylene (10) octadecyl ether, polyoxyethylene (15) hexadecyl ether and mixtures thereof.

9. The method of claim 7 wherein the second surfactant is selected from the group consisting of cetyltrimethylammonium bromide, a sodium salt of branched alkyl sulfonate, polyoxyethylene (100) stearyl ether, polyoxyethylene (20) oleyl ether, and polyoxyethylene (23) dodecyl ether and mixtures thereof.
